(19) United States
(12) Patent Application Publication
(10) Pub. No.: US 2010/0219012 A1
(43) Pub. Date: Sep. 2, 2010

(54) PASSIVE SPEAKER SYSTEM FOR PHONES AND OTHER DEVICES

(75) Inventor: Robert Baumbach, Sylmar, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Gryphon Corporation, Sylmar, CA (US)

(21) Appl. No.: 12/539,449

(22) Filed: Aug. 11, 2009

Related U.S. Application Data
(60) Provisional application No. 61/087,942, filed on Aug. 11, 2008.

(51) Int. Cl. G10K 11/00

(52) U.S. Cl. 181/177

(57) ABSTRACT

An amplification device for use with a phone or other electronic device having a speaker. The amplification device typically includes an amplification structure having an input end and an output end, and an adapter located proximal to the input end and configured to engage a phone or other electronic device such that a speaker on the phone or other electronic device emanates sound into the input end, whereby the sound is amplified by the amplification structure.

### CROSS-REFERENCES TO RELATED APPLICATIONS

This application is a non-provisional application claiming the benefit of U.S. Application No. 61/087,942, filed Aug. 11, 2008, entitled “PASSIVE SPEAKER SYSTEM FOR PHONES AND OTHER DEVICES,” which is hereby incorporated by reference in its entirety.

### BACKGROUND

The present invention relates generally to audio amplification, and more particularly to amplification of sound produced by speakers on hand-held, or other devices, such as phones.

Many phones or other small electronic devices have built-in speakers. Typically these built-in speakers on phones are used for the “speakerphone” feature, however on many phones, or other devices, the speaker can be used for playing musical or audio files that are stored on the device. When used as a music player, the built-in speaker in such devices is usually not loud enough to provide satisfactory sound quality. In addition, the apparent frequency range of the built-in speaker is typically inadequate for satisfactory listening.

Therefore it is desirable to provide systems and methods that overcome the above and other problems.

### BRIEF SUMMARY

The present invention provides systems and methods for amplifying sound emanating from a phone or other electronic devices.

According to various embodiments, an amplification device is provided for use with phones or other small electronic devices that have built-in speakers. In one embodiment, the amplification device comprises an acoustic horn and an adaptor configured to fit over the phone's/device's built-in speaker.

According to one aspect, an amplification device for use with a phone or other electronic device having a speaker is provided. The amplification device typically includes an amplification structure and an adapter configured to attach an end of the structure proximal to the speaker on a phone or other electronic device. In certain aspects, the amplification structure is substantially horn-shaped.

According to yet another aspect, a method is provided for amplifying an audio signal emanating from a speaker of a phone or other electronic device. The method typically includes providing an amplification device having an amplification portion and an adapter portion, the adapter portion configured to attach an end of the amplification portion proximal to the speaker on a phone or other electronic device, and attaching the adapter portion to a phone or other device, whereby when sound emanates from the speaker, the amplification portion amplifies the sound. In certain aspects, the amplification structure is substantially horn-shaped.

According to a further aspect, an amplification device is provided for use with a phone or other electronic device having a speaker. The amplification device typically includes an amplification structure having an input end and an output end, and an adapter located proximal to the input end and configured to engage a phone or other electronic device such that a speaker on the phone or other electronic device emanates sound into the input end, and whereby the sound is amplified by the amplification structure. In certain aspects, the amplification structure is substantially horn-shaped, and a cross section of the input end is smaller than a cross section of the output end. In certain aspects, an inner cross section of the amplification structure constantly increases from the input end to the output end. In certain aspects, an inner cross section of the amplification structure increases exponentially from the input end to the output end. In certain aspects, the amplification structure is integrated in the dashboard or other member of a conveyance vehicle.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an example of an amplification device attached to a phone device, according to one embodiment.

### DETAILED DESCRIPTION

According to various embodiments, an amplification device is provided for use with phones or other small electronic devices that have one or more built-in speakers. The amplification device, in one embodiment, comprises an acoustic horn, or other amplification structure, and an adaptor configured to engage the electronic device, e.g., fit over the electronic device's built-in speaker(s). Typically these built-in speakers on phones are used for the “speakerphone” feature, however on many phones, such as the Apple iPhone®, the speaker can be used for playing any musical or audio files that are stored on the phone. When used as a music player, the built-in speaker in such phones is usually not loud enough to be satisfactory. In addition, the apparent frequency range of the built-in speaker is inadequate for satisfactory listening.

The device may be used with the iPhone, however by changing the configuration of the input adaptor, the device can be utilized with a large number of electronic devices. In this document, reference to a “phone” is understood to mean a cellular phone, or a handheld phone that may remotely connect with a base station, having a built in speaker, typically provided for speakerphone use, or any other suitable electronic device with a built-in speaker. Examples include computers such as laptop or tablet computers, music players (e.g., mp3 players), video players (e.g., portable DVD players), hand-held game systems (e.g., Nintendo DS) and so forth. In one embodiment, the amplification device is a passive speaker device that includes an amplification horn that attaches to the phone and amplifies the sound provided by the phone's built-in speaker(s). A high level of amplification may be achieved using the amplification device as disclosed herein. Also, the full frequency range of a phone's built in speaker may be realized. In one embodiment, the inside of the amplification device (e.g., horn-shaped structure) is textured to tune high frequency response. For example, texture may be added to a mold so that the texture is applied automatically. The texture may also be modified to tune the high frequency response as desired to create a more pleasant balance of sounds.

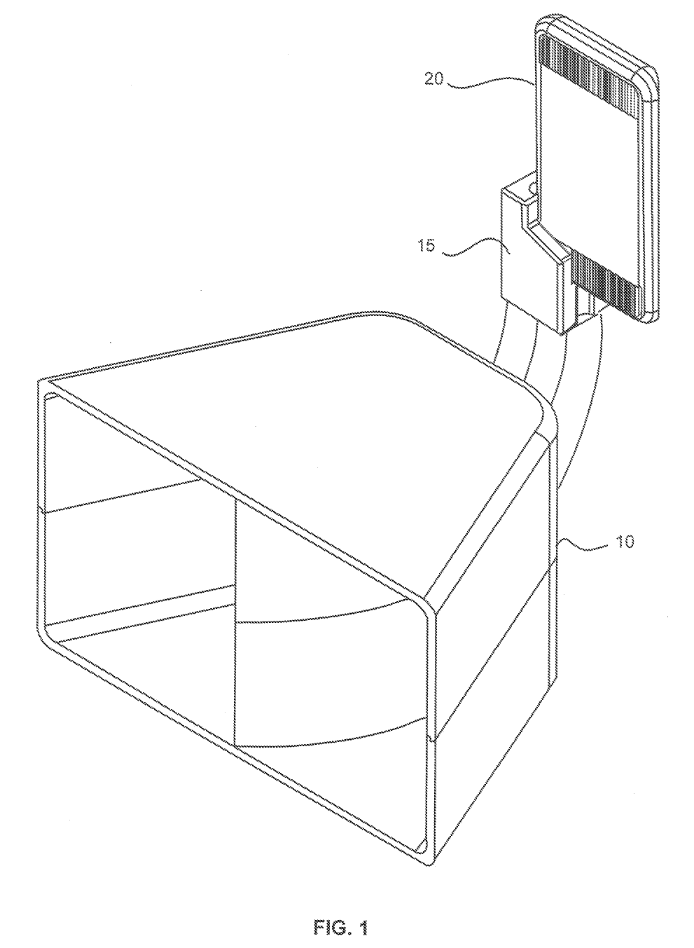

FIG. 1 illustrates an example of an amplification device 10 having a horn-shaped structure attached to a phone device 20, according to one embodiment. The adaptor or connector 15 attaches the phone 20 to the device 10. The connector typically includes an opening or input to the structure that allows sound from one (or more) speaker on the engaged phone or other electronic device to enter the amplification structure, whereby amplification of the sound occurs due to the acoustic characteristics and shape of the structure. In certain aspects, adaptor/connector 15 is air tight, preferably made of a flexible rubbery material, and can be easily exchanged for a different connector in order to accommodate different phones, both now and in the future, or other electronic devices. The connector 15 is preferably soft enough to allow easy insertion and removal of the phone without scratching the case of the phone. In certain aspects, the connector is sufficiently stiff to support the phone while it is in a horizontal or vertical orientation. Alternately, the amplification device can be fitted with a small driver (speaker) installed within a custom connector to allow the amplification device to be used with any audio device with a headphone jack, such as an iPod®.

In certain aspects, the amplification device as shown may be folded upon itself in order to minimize the overall dimensions and make the amplification device compact for transportation. The length of an amplification device is expressed as the distance from the input to the output. Within certain limits, the longer the device, the louder the sound and the lower the lowest frequency that can be reproduced. In this regard, the amplification device can be made any size, but since the device needs to be a practical size, the folded design of the device results in the maximum performance for a given outer size. In one aspect, the dimensions of an amplification device are approximately 8″ across and 5″ high (6″ including adaptor, but without the phone) and the horn structure is about 5″ deep (the elbow and adaptor add another 1.5″ or so). The range of practical sizes varies greatly, however. For example, anything from ⅛ the size mentioned above to about 5 times that size or larger may be used. In one aspect, the “length” of the horn is about 18″ (i.e., the path of the sound from input to output). The upper limit of horn length is about 35 feet, because acoustical theory states that that length will produce the lowest frequencies audible to the human ear. As one example, a six foot horn is a very fine performer, and a folded horn of this size can be fitted into an enclosure roughly 3′ ×4′ across and 3′ deep.

One advantage of the amplification device is that it significantly amplifies the sound coming from an engaged electronic device's speaker without requiring any power or wires.

In certain aspects, the shape of the amplification device is carefully constructed to provide a constantly increasing (inner) cross-section from the input to the output. For optimum performance, the cross-section should increase in an exponential manner, however, a generally increasing cross section with constant or non-constant increase may be used. The input end of the amplification device should ideally be approximately equal in cross-section to the size of the phone's built-in speaker. In one embodiment, an airtight seal between the phone (speaker) and the adaptor is provided. Useful materials for constructing the amplification device include plastics, rubber, metals and wood. In certain aspects, the horn structure is made of plastic and the adaptor is made out of artificial rubber. Wood is also a good material for the horn structure and/or the adaptor as it provides good high frequency attenuation and balanced sound. It should be appreciated that the external housing may be the same shape as or different than the internal structure that forms the horn-shaped amplification structure.

In certain aspects, the amplification device is designed to sit on a flat surface such as a desk or table, and can be oriented vertically or horizontally. The ability to be oriented horizontally or vertically is useful, as some phones or devices prefer one orientation or the other depending upon their design.

In certain aspects, the structure of the amplification device is integrated in the dashboard or other member of a conveyance vehicle such as a car, golf cart, motorcycle, boat, sail boat, airplane, and other conveyances. In certain aspects, the amplification device is integrated on a stand or easel or other structure that can be used in a home or office or other environment.

In certain aspects, the amplification device is designed so that a phone or other electronic device can be charged or synchronized while the phone or other device is attached to the amplification device.

In certain aspects, the amplification device is designed so that the microphone on an engaged phone is not obscured, allowing the device to be employed during two-way phone conversations.

In certain aspects, the amplification device is designed so that the various controls on the phone are operable without removing the phone from the device. The phone's volume control, and all other controls should be accessible at all times. Phone calls may be placed or received while the phone is installed and in use in the device.

Very often, cellular phones cannot be used within a few feet of traditional speakers because the phone transmits radio waves that cause interface, and an audio “buzz” is heard over the speakers whether or not the phone is connected to the speaker. Because the device does not need to contain electrical components, there is advantageously no electrical interference between the phone and the device, and no shielding is needed.

Since the device contains no components, it is inherently fully waterproof and shock proof, and is temperature insensitive. Further, the device requires no ventilation.

Following are salient features of a device according to various embodiments:

Utilizes the speaker built into many phones and similar items
Requires no power or wires
No electrical interference between the phone and the amplification device.
Does not interfere with the phone's other functions while using the device. All controls and displays remain fully accessible.
Can make or receive phone calls when a phone is installed in the amplification device
Air Tight Seal between device and phone's speaker
Increasing cross section of the horn structure as sound waves travel from input to output, preferably exponential.
Can orient amplification device in horizontal position or vertical.
Can use as speaker phone
Amplifies sound when playing audio or video
Can charge phone or other electronic device while in use in amplification device
Amplification device may be folded to minimize outside dimensions
Horn has an inside cross-sectional area that increases, e.g., exponentially, from the input to the output. Ideally, there are no sharp direction changes and no areas where the cross-sectional area remains constant.
Directional sound

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An amplification device for use with a phone or other electronic device having a speaker; the amplification device comprising:
an amplification structure having an input end and an output end; and
an adapter located proximal to the input end and configured to engage a phone or other electronic device such that a speaker on the phone or other electronic device emanates sound into the input end and whereby the sound is amplified by the amplification structure.

2. The amplification device of claim 1, wherein the amplification structure is substantially horn-shaped, and wherein a cross section of the input end is smaller than a cross section of the output end.

3. The amplification device of claim 1, wherein a cross section of the amplification structure constantly increases from the input end to the output end.

4. The amplification device of claim 1, wherein a cross section of the amplification structure increases exponentially from the input end to the output end.

5. An amplification device for use with a phone or other electronic device having a speaker; the amplification device comprising:
an amplification structure; and
an adapter configured to attach an input end of the structure proximal to a speaker on a phone or other electronic device, whereby the amplification structure amplifies sound emanating from the speaker.

6. The amplification device of claim 5, wherein a cross section of the amplification structure constantly increases from the input end to an output end.

7. The amplification device of claim 5, wherein a cross section of the amplification structure increases exponentially from the input end to an output end.

8. A method of amplifying the sound of an audio signal emanating from a speaker of a phone or other electronic device, the method comprising:
providing an amplification device having an amplification portion and an adapter portion, the adapter portion configured to engage a speaker on a phone or other electronic device proximal to an input end of the amplification portion; and
attaching a phone or other device to the adapter portion, whereby when sound emanates from the speaker, the amplification portion amplifies the sound.

9. The method of claim 8, wherein the amplification portion is substantially horn-shaped.

10. The method of claim 8, wherein a cross section of the amplification portion constantly increases from the input end to an output end.

11. The method of claim 8, wherein a cross section of the amplification portion increases exponentially from the input end to an output end.

12. The method of claim 8, wherein a cross section of the input end is smaller than a cross section of the output end.

13. The method of claim 8, wherein the amplification device is integrated in the dashboard or other member of a conveyance vehicle.

14. The amplification device of claim 1, wherein the amplification structure is integrated in the dashboard or other member of a conveyance vehicle.

15. The amplification device of claim 5, wherein the amplification structure is integrated in the dashboard or other member of a conveyance vehicle.
